(19) United States
(12) Patent Application Publication
(10) Pub. No.: US 2025/0105284 A1
(43) Pub. Date: Mar. 27, 2025

(54) HIGH-NICKEL TERNARY POSITIVE ELECTRODE MATERIAL HAVING COBALT GRADIENT, PREPARATION METHOD THEREFOR, AND LITHIUM-ION BATTERY

(71) Applicant: Ningbo Ronbay New Energy Technology Co., Ltd., Yuyao Ningbo (CN)

(72) Inventors: Bingbing LI, Yuyao Ningbo (CN); Zhenhao QU, Yuyao Ningbo (CN); Peipei DONG, Yuyao Ningbo (CN); Zhiyuan LIU, Yuyao Ningbo (CN); Jian YU, Yuyao Ningbo (CN)

(21) Appl. No.: 18/977,680

(22) Filed: Dec. 11, 2024

Related U.S. Application Data
(63) Continuation of application No. PCT/CN2023/127367, filed on Oct. 27, 2023.

(30) Foreign Application Priority Data
Aug. 31, 2022 (CN) 202211057150.7

(51) Int. Cl. H01M 4/525; C01G 53/00; H01M 10/0525

(52) U.S. Cl. CPC H01M 4/525; C01G 53/50; H01M 10/0525; C01P 2002/52; C01P 2004/03; C01P 2004/61; C01P 2006/40

(57) ABSTRACT

A high-nickel ternary positive electrode material, has a structural formula of LiₓNiₐM_{b}Co_{c}N_{z}O₂. A content of a cobalt element within a range of 1.5 μm from a surface of the positive electrode material accounts for 48%-85% of a content of the cobalt element in the positive electrode material. A high-nickel ternary positive electrode material is designed in the present application, which has a specific structure with cobalt element distributed gradiently from inside to outside, and thus a high-nickel low-cobalt positive electrode material product with good stability can be directly obtained. The content of cobalt in the near-surface region and surface region of the positive electrode material is high, and high-content cobalt may react with Li⁺that cannot be re-inserted to generate lithium cobaltate. This increases part of the capacity and avoids the generation of residual alkali, thereby improving the capacity and cycle performance of the high-nickel ternary positive electrode material.

### CROSS-REFERENCE TO RELATED APPLICATIONS

The present application is a continuation of International Application No. PCT/CN2023/127367, filed on Oct. 27, 2023, which claims priority to Chinese Patent Application No. 202211057150.7, filed with the China National Intellectual Property Administration on Aug. 31, 2022. The disclosures of the aforementioned applications are hereby incorporated by reference in their entireties.

### TECHNICAL FIELD

The present application belongs to the technical field of high-nickel ternary positive electrode materials, relates to a high-nickel ternary positive electrode material and its preparation method, and a lithium-ion battery and, in particular, to a high-nickel ternary positive electrode material having cobalt gradient and its preparation method, and a lithium-ion battery.

### BACKGROUND

Low-cobalt compositions in the power battery industry are a major trend of technological development. High-nickel low-cobalt ternary positive electrode materials with high energy density and low manufacturing cost are increasingly becoming a major trend of future technological development.

Most of high-nickel low-cobalt positive electrode materials that have been developed so far have the characteristics of excellent electrochemical performance and low cost. However, due to the reduction of cobalt content, high-nickel low-cobalt materials have low structural stability, low first-cycle coulombic efficiency, low rate performance, poor cycle stability, high residual alkali, and limited capacity utilization. Regarding these problems, a solution of coating with coating agents is generally adopted in the industry for improving cycle stability, reducing residual alkali, etc. For example, in patent CN114142001A (chlorine-doped carbon quantum dots and ZrO₂ are used as a coating layer) and patent CN114068894A (lithium lanthanum zirconate is used as a coating layer), the electronic conductivity, ionic conductivity, and structural stability of ternary positive electrode materials are improved to a certain extent.

However, these coating agents cannot completely coat the surface of the material, causing part of the positive electrode material to be exposed and in direct contact with an electrolyte solution, leading to inevitable decomposition of the electrolyte solution, thereby resulting in a decrease of battery efficiency. The dot-like coating agent on the surface of the positive electrode material is prone to be detached, not only losing the coating effect, but also producing a large number of side reactions by detached compounds, thereby resulting in battery failure. In addition, technological measures for the coating of coating agents directly lead to the introduction of equipment in actual production, the complexity of workshop design, and becoming a key point of the process, operating flow and etc.

Therefore, how to obtain a more suitable high-nickel low-cobalt positive electrode material and solve the above-mentioned technical problems existing in high-nickel low-cobalt positive electrode materials and coating-modified high-nickel low-cobalt positive electrode materials in the prior art, have become one of the focuses which are paid wide attention by many front-line researchers and R&D-oriented enterprises in the industry.

### SUMMARY

In view of this, the technical problem to be solved by the present application is to provide a high-nickel ternary positive electrode material and a preparation method thereof, and a lithium-ion battery, especially a high-nickel ternary positive electrode material having cobalt gradient. The high-nickel ternary positive electrode material provided by the present application has a specific structure with cobalt element distributed gradiently from inside to outside, which ensures a high capacity with a better stability, and the process thereof is simple, the conditions thereof are mild and easy to control, being more conducive to the promotion and application of industrialized large-scale production.

The present application provides a high-nickel ternary positive electrode material, having a structural formula of LiₓNiₐM_{b}Co_{c}N_{z}O₂;
where 1≤x≤1.04, 0.70≤a≤0.96, 0.02≤b≤0.28, 0.001≤z≤0.015, c=1−a−b, c>0;
M includes one or more of Mn, Al, Mg, and Fe;
N includes one or more of Ti, Ta, B, Sc, Sn, Y, Zr, Mg, Cr, Nb, W, and Mo; and
a content of a cobalt element within a range of 1.5 μm from a surface of the positive electrode material accounts for 48%-85% of a content of the cobalt element in the positive electrode material.

In an embodiment, the positive electrode material has a uniform spherical particle morphology; and
a particle size of the positive electrode material is 3.2-20 μm.

In an embodiment, the cobalt element is distributed in a decreasing gradient from the surface to a center of the positive electrode material;
in the positive electrode material, a concentration of the cobalt element in a surface region and a near-surface region is higher than that in the interior.

In an embodiment, the center of the positive electrode material does not contain cobalt element;
the positive electrode material does not have a coating structure or a composite structure;
the ternary positive electrode material includes a single-crystal ternary positive electrode material or a poly-crystal ternary positive electrode material.

The present application provides a preparation method for a high-nickel ternary positive electrode material, including the following steps:
1) mixing a nickel source, an M source and water to obtain a salt solution;
2) injecting a cobalt source solution into the salt solution at first, and at the beginning of obtaining a mixed salt solution, injecting the mixed salt solution, a complexing agent and a precipitating agent into a reaction device for a co-precipitation reaction, and after a period of solution, and then continuously injecting the mixed salt solution, the complexing agent and the precipitating agent into the reaction device for the co-precipitation reaction, to finally obtain a ternary material precursor;
3) continuously mixing the ternary material precursor obtained in the above steps, a lithium source and a doping agent, and then sintering in an oxygen-containing atmosphere, to obtain the high-nickel ternary positive electrode material.

In an embodiment, a total concentration of the nickel source and the M source in the salt solution is the same as a concentration of the cobalt source solution; and
a ratio of a volume of the cobalt source solution to a total volume of the salt solution is (0.45-1): 1.

In an embodiment, a duration of the period of time is 10-24 h; and
an injection rate of the cobalt source solution is greater than that of the mixed salt solution.

In an embodiment, the lithium source includes one or more of lithium carbonate, lithium nitrate, lithium acetate, and lithium hydroxide;
the nickel source comprises one or more of nickel sulfate, nickel nitrate, and nickel chloride; and
the cobalt source comprises one or more of cobalt sulfate, cobalt nitrate, and cobalt chloride.

In an embodiment, the M source includes one or more of M sulfate, M nitrate, and M chloride;
the complexing agent comprises one or more of aqueous ammonia solution, ammonium sulfate, EDTA, oxalic acid, sodium carbonate, and sodium bicarbonate; and
the precipitating agent comprises one or more of NaOH, Na₂CO₃, H₂C₂O₄, (NH₄)₂C₂O₄, and (NH₄)₂CO₃.

In an embodiment, a temperature of the co-precipitation reaction is 55-65° C.;
a pH value of a solution system of the co-precipitation reaction is 10-12; and
a time of the co-precipitation reaction is 18-36 h.

In an embodiment, a volume concentration of oxygen in the oxygen-containing atmosphere is greater than or equal to 90%; and
a molar ratio of the ternary material precursor to the lithium source is 1:(1-1.04).

In an embodiment, the sintering includes two-stage of sintering;
a heating rate of a first stage of sintering is 1-3° C./min;
a temperature of the first stage of sintering is 400-500° C.; and
a holding time of the first stage of sintering is 5-8 h.

In an embodiment, a heating rate of an second stage of sintering is 1-10° C./min;
a temperature of the second stage of sintering is 700-900° C.; and
a holding time of the second stage of sintering is 12-24 h.

The present application further provides a lithium-ion battery, the positive electrode material thereof includes the high-nickel ternary positive electrode material described in any one of the above technical solutions or the high-nickel ternary positive electrode material prepared by the preparation method described in any one of the above technical solutions.

In an embodiment, the lithium-ion battery includes a lithium-ion power battery; and
the high-nickel ternary positive electrode material comprises a high-nickel low-cobalt positive electrode material.

The high-nickel ternary positive electrode material includes a high-nickel and low-cobalt positive electrode material.

The present application provides a high-nickel ternary positive electrode material, having a structural formula of LiₓNiₐM_{b}Co_{c}N_{z}O₂; where 1≤x≤1.04, 0.70≤a≤0.96, 0.02≤b≤0.28, 0.001≤z≤0.015, c=1−a−b, c>0; M includes one or more of Mn, Al, Mg, and Fe; N includes one or more of Ti, Ta, B, Sc, Sn, Y, Zr, Mg, Cr, Nb, W, and Mo; and a content of a cobalt element within a range of 1.5 μm from a surface of the positive electrode material accounts for 48%-85% of a content of the cobalt element in the positive electrode material. Compared with the prior art, the present application addresses the limitations of poor cycle stability, excessive residual alkali, and capacity utilization in the existing high-nickel low-cobalt ternary positive electrode materials. However, the solution of coating with a coating agent commonly used in the industry has problems such as difficulty in forming a complete coating, easy detachment of the coating agent, and complex process. According to the study of the present application, the high-nickel ternary material has cation disorder and layered structure collapse during cycling, causing that part of Li⁺ions cannot be inserted into inner layers, which results in a decrease in efficiency of in battery. Moreover, the solution of coating with coating agents is not the best solution to the problem.

Based on this, in the present application a high-nickel ternary positive electrode material is specially designed, which has a specific structure with cobalt element distributed gradiently from inside to outside, and thus a high-nickel low-cobalt positive electrode material product with good stability can be directly obtained. Doping elements in the present application occupy the positions of Ni²⁺and Co³⁺. in the positive electrode material, reducing the cation disorder in the lithium layer. On the other hand, the ion radius of the doping elements is larger than that of Mn²⁺, thus the unit cell may be broadened to provide a larger space for the deinsertion and insertion of Li⁺, which is conducive to the deinsertion and insertion of Li⁺, thereby improving the rate performance of the positive electrode material. However, since Li⁺will react with H₂O and CO₂ to generate residual alkali in the near-surface region and the surface region of the material, there is a risk of material cracking and failure after multiple cycles. A positive electrode material having higher cobalt content in the near-surface region and surface region is specially designed in the present application. High-content cobalt may react with Li⁺that cannot be re-inserted to generate lithium cobaltate, this stabilizes the layered structure and suppresses cation disorder, and increases part of the capacity and avoids the generation of residual alkali, thereby improving the capacity and cycle performance of the high-nickel ternary positive electrode material and reducing problems such as residual alkali and gas generation. Furthermore, in the present application, the material having cobalt gradient is designed starting from the precursor, ensuring good electrical performance, cycle stability and low residual alkali of the high-nickel low-cobalt material. There is no artificially designed coating layer, the complexity of the subsequent process is reduced, and the present application has the characteristics of simple process, low cost and being suitable for large-scale industrialization.

The present application further provides a preparation method of a high-nickel low-cobalt ternary positive electrode material having cobalt gradient. The cobalt source is gradiently added over time during the preparation process to directly obtain a high-nickel low-cobalt precursor of high-nickel ternary material. The cobalt element is distributed gradiently from inside to outside. Compared with conventional high-nickel low-cobalt ternary positive electrode materials, the high-nickel ternary positive electrode material prepared using the precursor ensures high capacity, and at the same time, the artificially designed coating layer is replaced with the near-surface region having higher cobalt content, thus there is no risk of failure caused by the detaching or cracking of the coating layer, therefore, the high-nickel ternary positive electrode material has more excellent stability. The high-nickel low-cobalt precursor of high-nickel ternary material is directly obtained in the present application, and the provided preparation method of the ternary positive electrode material having cobalt gradient is simple and easy to implement with mild and controllable conditions, and is more suitable for large-scale industrial production, and the morphology and quality of the precursor are effectively controlled to ensure the performance of the finished positive electrode material.

The experimental results show that, under the conditions of controlling the content of cobalt element and particle size in Comparative Examples 1-2 and Examples 1-3 to remain unchanged, a low-cobalt high-nickel ternary precursor prepared by an original method adopted in Comparative Example 1 had evenly distributed cobalt element and the content of cobalt element on the surface is only 31% of the total content of cobalt. Comparative Example 2 adopted the gradient method of the present application, the cobalt source was added at the beginning of the reaction; due to the overall low cobalt content, the final cobalt content on the outer surface of the material was only 34%. Therefore, the function of protecting the positive electrode material and reducing residual alkali in the electrolyte solution cannot be achieved. In the Examples 1, 2 and 3 of the present application, the cobalt source was added after the reaction lasts for 10, 11, and 12 hours respectively, thereby obtaining ternary precursors having cobalt gradient with a cobalt concentration on the surface of 56%, 65% and 74%, achieving the expected effects of the present application.

Comparative Examples 3, 4, 5, 6, 7, 8 all had the above-mentioned similar effects after the proportion of raw materials were changed and comparison with the corresponding Examples was conducted.

### BRIEF DESCRIPTION OF DRAWINGS

FIG. 1 is a schematic diagram of a preparation process flow of a high-nickel low-cobalt ternary positive electrode material having cobalt gradient provided by the present application.

FIG. 2 is a high-magnification scanning electron microscope image of a precursor of the high-nickel ternary positive electrode material having cobalt gradient prepared by Example 1 of the present application.

FIG. 3 is a high-magnification scanning electron microscope image of a precursor of the high-nickel ternary positive electrode material having cobalt gradient prepared by Comparative Example 1 of the present application.

### DESCRIPTION OF EMBODIMENTS

For further understanding the present application, embodiments of the present application are described below in conjunction with examples. However, it should be understood that these descriptions are only to further illustrate the features and advantages of the present application and are not intended to limit the patent claims of the present application.

All raw materials in the present application, without any particular limitation as to their source, are either commercially available or prepared in accordance with conventional methods known to the person skilled in the art.

For all raw materials in the present application, there is no special restriction on the purity thereof. In the present application, analytical purity or the conventional purity requirements in the field of preparation of high-nickel positive electrode materials is adopted.

For all raw materials in the present application, the brand names and abbreviations thereof are conventional brand names and abbreviations in the art, and each of which is clear and unambiguous in the field of its relevant uses. The raw materials can be purchased commercially or prepared using conventional methods by person skilled in the art, depending on their brand names, abbreviations, and corresponding uses.

For the processes used in the present application, the abbreviations thereof are all conventional abbreviations in the field, and specific steps and conventional parameters of each abbreviation are clear and unambiguous in the relevant fields. The person skilled in the art is capable of implementing the processes in conventional ways according to the abbreviations.

The present application provides a high-nickel ternary positive electrode material having a structural formula of LiₓNiₐM_{b}Co_{c}N₂O₂;
where, 1≤x≤1.04, 0.70≤a≤0.96, 0.02≤b≤0.28, 0.001≤z≤0.015, c=1−a−b, c>0;
M includes one or more of Mn, Al, Mg, and Fe;
N includes one or more of Ti, Ta, B, Sc, Sn, Y, Zr, Mg, Cr, Nb, W, and Mo;
a content of a cobalt element within a range of 1.5 μm from a surface of the positive electrode material accounts for 48% to 85% of a content of the cobalt element in the positive electrode material.

In the present application, 1≤x≤1.04, which may be 1.01≤x≤1.03;
0.70≤a≤0.96, which may be 0.75≤a≤0.90, or 0.80≤a≤0.85;
0.02≤b≤0.28, which may be 0.05≤b≤0.25, or 0.1≤b≤0.2;
0.001≤z≤0.015, which may be 0.001-0.015, or 0.005-0.008, or 0.004-0.012, or 0.0002-0.0035.

In the present application, M includes one or more of Mn, Al, Mg, and Fe, and may be Mn, Al, Mg, or Fe.

In the present application, N is a doping element. N includes one or more of Ti, Ta, B, Sc, Sn, Y, Zr, Mg, Cr, Nb, W, and Mo, and may be Ti, Ta, B, Sc, Sn, Y, Zr, Mg, Cr, Nb, W, or Mo.

In the present application, the content of the cobalt element within a range of 1.5 μm from the surface of the positive electrode material accounts for 48% to 85%, for example 56% to 84%, 63% to 82%, and 68% to 80% of the content of the cobalt element in the positive electrode material. Where, a distance from the surface is 0-1.5 μm, or 0.1-1.3 μm, or 0.3-1.0 μm, or 0.5-0.8 μm.

In the present application, the positive electrode material has a uniform spherical particle morphology.

In the present application, the positive electrode material has a particle size of 3.2-20 μm, for example 5-17 μm, and 8-14 μm.

In the present application, the cobalt element is distributed in a decreasing gradient from the surface to the center in the positive electrode material.

In the present application, in the positive electrode material, the concentration of the cobalt element in a surface region and a near-surface region is higher than that in the interior.

In the present application, the center of the positive electrode material does not contain cobalt element.

In the present application, the positive electrode material does not have a coating structure or a composite structure.

In the present application, the ternary positive electrode material includes a single-crystal ternary positive electrode material or a poly-crystal ternary positive electrode material.

In the present application, in order to complete and detail the overall technical solutions and better improve the capacity and cycle stability of high-nickel ternary positive electrode materials, and further reduce problems such as residual alkali and gas generation, the above-mentioned high-nickel ternary positive electrode material may specifically be consist of the following.

The positive electrode material in the present application has a structural formula of LiₓNiₐM_{b}Co_{c}N_{z}O₂, where 1≤x≤1.04, 0.70≤a≤0.96, 0.02≤b≤0.28, 0.001≤z≤0.015, c=1−a−b.

Specifically, M is at least one of Mn, Al, Mg or Fe element.

Specifically, N is a doping element, selected from at least one of Ti, Ta, B, Sc, Sn, Y, Zr, Mg, Cr, Nb, W or Mo.

In the present application, the content of cobalt element within a range of 1.5 μm from the surface of the positive electrode material is 48% to 85% of the total addition amount of cobalt element, and the particle size of the positive electrode material prepared by the present application ranges from 3.2 μm to 20 μm.

The high-nickel low-cobalt ternary positive electrode material having cobalt gradient provided by the present application is a single-crystal or poly-crystal ternary positive electrode material.

The positive electrode material designed by the present application has a high cobalt content in the surface region and the near-surface region. High-content cobalt may react with Li⁺that cannot be re-inserted, to form lithium cobaltate. This can stabilize the layered structure and suppress cation disorder, at the same time, increase part of the capacity and avoid the generation of residual alkali, thereby improving the capacity and cycle performance of the high-nickel ternary positive electrode material and reducing problems such as residual alkali and gas generation. Furthermore, in the present application, the cobalt-gradient material is designed starting from the precursor to ensure good electrical performance, cycle stability and low residual alkali of the high-nickel low-cobalt material, and there is no artificially designed coating layer, the complexity of the subsequent process is reduced, and the present application has the characteristics of simple process and low cost, being suitable for large-scale industrialization.

The present application provides a preparation method of a high-nickel ternary positive electrode material, including the following steps:
1) mixing a nickel source, an M source and water to obtain a salt solution;
2) injecting a cobalt source solution into the salt solution at first, and at the beginning of obtaining a mixed salt solution, injecting the mixed salt solution, a complexing agent and a precipitating agent into the reaction device for a co-precipitation reaction, and after a period of time, continuously injecting the cobalt source solution to continuously obtain the mixed salt solution, and continuously injecting the mixed salt solution, the complexing agent and the precipitating agent into the reaction device for the co-precipitation reaction, to finally obtain a ternary material precursor;
3) continuously mixing the ternary material precursor obtained in the above steps, a lithium source and a doping agent, and then sintering in an oxygen-containing atmosphere, to obtain the high-nickel ternary positive electrode material.

In the present application, a nickel source, an M source and water are firstly mixed to obtain a salt solution.

In the present application, a total concentration of the nickel source and the M source in the salt solution is the same as a concentration of the cobalt source solution.

In the present application, a ratio of a volume of the cobalt source solution to a total volume of the salt solution is (0.45-1):1, for example (0.5-0.9):1, and (0.6-0.8):1.

In the present application, the cobalt source solution is firstly injected into the salt solution, and at the beginning of obtaining a mixed salt solution, the mixed salt solution, a complexing agent and a precipitating agent are injected into the reaction device for a co-precipitation reaction, and after a period of time, the cobalt source solution are continuously injected to continuously obtain the mixed solution, and then the mixed salt solution, the complexing agent and the precipitating agent are continuously injected into the reaction device for the co-precipitation reaction, to finally obtain a ternary material precursor.

In the present application, firstly nickel and M react together to form a precursor material. After reacting for a period of time, Co is added to participate in the reaction. It may be achieved that there is no Co in a core region of the particle, while there is a large content of Co in an edge portion of the particle. The content of Co in the edge portion may be in gradient-type or jump-type, which conforms to the structure that Co located from inside to outside in the particle has a concentration from small to large.

In the present application, a duration of the period of time is 10-24 h, for example 11-22 h, 12-20 h, and 13-19 h.

In the present application, an injection rate of the cobalt source solution is greater than an injection rate of the mixed salt solution.

The present application adopts a method in which the injection rate of the cobalt source solution is greater than the injection rate of the mixed salt solution, thereby ensuring that an amount of Co is greater than that of nickel and M, and a high concentration of Co is maintained in the near-surface region after the reaction, achieving effects of reducing residual alkali and the like.

In the present application, the lithium source includes one or more of lithium carbonate, lithium nitrate, lithium acetate, and lithium hydroxide, for example lithium carbonate, lithium nitrate, lithium acetate, or lithium hydroxide.

In the present application, the nickel source includes one or more of nickel sulfate, nickel nitrate, and nickel chloride, for example nickel sulfate, nickel nitrate, or nickel chloride.

In the present application, the cobalt source includes one or more of cobalt sulfate, cobalt nitrate, and cobalt chloride, for example cobalt sulfate, cobalt nitrate, or cobalt chloride.

In the present application, the M source includes one or more of M sulfate, M nitrate, and M chloride, for example M sulfate, M nitrate, or M chloride.

In the present application, the complexing agent includes one or more of an ammonia aqueous solution, ammonium sulfate, EDTA, oxalic acid, sodium carbonate, and sodium bicarbonate, for example an ammonia aqueous solution, ammonium sulfate, EDTA, oxalic acid, sodium carbonate, or sodium bicarbonate.

In the present application, the precipitating agent includes one or more of NaOH, Na₂CO₃, H₂C₂O₄, (NH₄)₂C₂O₄, and (NH₄)₂CO₃, for example NaOH, Na₂CO₃, H₂C₂O₄, (NH₄)₂C₂O₄, and (NH₄)₂CO₃.

In the present application, a temperature of the co-precipitation reaction is 55-65° C., for example 57-63° C., and 59-61° C.

In the present application, a pH value of the solution system of the co-precipitation reaction is 10-12, for example 10.4-11.6, and 10.8-11.2.

In the present application, a time of the co-precipitation reaction is 18-36 h, for example 22-32 h, and 26-28 h.

In the present application, finally, the ternary material precursor obtained in the above steps, a lithium source, and a doping agent are continuously mixed, and subjected to sintering in an oxygen-containing atmosphere, so as to obtain a high-nickel ternary positive electrode material.

In the present application, a volume concentration of oxygen in the oxygen-containing atmosphere is greater than or equal to 90%, for example greater than or equal to 92%, and greater than or equal to 94%.

In the present application, a molar ratio of the ternary material precursor to the lithium source is 1:(1-1.04), for example 1:(1.005-1.035), 1:(1.01-1.03), and 1:(1.015-1.025).

In the present application, the sintering includes two-stage of sintering.

In the present application, a heating rate of the first stage of sintering is 1-3° C./min, for example 1.4-2.6° C./min, and 1.8-2.2° C./min.

In the present application, a temperature of the first stage of sintering is 400-500° C., for example 420-480° C., and 440-460° C.

In the present application, a holding time of the first stage of sintering is 5-8 h, for example 5.5-7.5 h, and 6-7 h.

In the present application, a heating rate of the second stage of sintering is 1-10° C./min, for example 3-8° C./min, and 5-6° C./min. In the present application, a temperature of the second stage of sintering is 700-900° C., for example 740-860° C., and 780-820° C.

In the present application, a holding time of the second stage of sintering is 12-24 h, for example 14-22 h, and 16-20 h.

In the present application, in order to complete and detail the overall technical solutions and better improve the capacity and cycle stability of high-nickel ternary positive electrode materials, and further reduce problems such as residual alkali and gas generation, the preparation method of the above-mentioned high-nickel ternary positive electrode material may specifically be the following.

A high-nickel low-cobalt ternary positive electrode material having cobalt gradient and a preparation method thereof are provided, including the following steps:
providing a nickel source, a cobalt source, an M source, a complexing agent, and a precipitating agent respectively; dissolving the nickel source and M source in water to prepare a salt solution 1; and dissolving the cobalt source in water to prepare a salt solution 2;
under stirring, injecting the salt solution 2 slowly into the salt solution 1 to obtain a mixed salt solution; then, injecting the mixed salt solution, the complexing agent, and the precipitating agent into a reaction kettle for co-precipitation reaction to prepare a precursor of high-nickel ternary material having cobalt gradient; where the addition rate of the salt solution 2 is greater than the addition rate of the salt solution 1 to ensure that the cobalt source participates more and more in the reaction, and finally a high-nickel ternary positive electrode material with more and more cobalt from inside to outside is obtained.

The lithium source is mixed with the precursor of high-nickel ternary material, and a doping agent is added to obtain a mixed material which is then placed in a heating device. The mixed material is subjected to sintering with programmed heating under oxygen flow condition, and after being cooled, a ternary positive electrode material having cobalt gradient is obtained.

Specifically, the conditions for preparing the precursor of high-nickel ternary material having cobalt gradient by co-precipitation reaction are that a temperature is 60° C.±5° C., a pH of the solution system is 10-12, and a reaction time is 18-36 h.

The obtained mixed material is placed in a heating device, and in the step of sintering with programmed heating under oxygen flow condition, the temperature is raised to 400-500° C. at a heating rate of 1-3° C./min, and the temperature is held for 5-8 h, and then the temperature is raised to 700-900° C. at a heating rate of 1-10° C./min, and the temperature is held for 12-24 h.

Specifically, an oxygen concentration in the oxygen atmosphere is above 90%.

Specifically, the concentrations of the nickel source and M source in the salt solution 1 are the same as the concentration of the cobalt source in the salt solution 2.

Specifically, in the step of continuously and slowly injecting the salt solution 2 into the salt solution 1 to perform a gradient reaction, a ratio of a total volume of the salt solution 2 to a total volume of the salt solution 1 is (0.45-1):1.

Specifically, in the step of mixing the lithium source and the precursor of high-nickel low-cobalt ternary material, the lithium source and the precursor of high-nickel low-cobalt ternary material are mixed evenly in a molar ratio of the lithium source to the precursor of high-nickel ternary material having cobalt gradient of 1:1-1.04:1.

Specifically, a content of cobalt element within the range of 1.5 μm from the surface of the positive electrode material is 48%-85%, for example 56%-84%, 63%-82%, or 71%-79% of a total addition amount of cobalt element.

Specifically, the addition amount of the doping agent is 0.0002-0.035, 0.001-0.015, 0.0026-0.0084, 0.0032-0.072, 0.004-0.012, or 0.005-0.008.

Specifically, the lithium source is selected from at least one of lithium carbonate, lithium nitrate, lithium acetate, or lithium hydroxide.

Specifically, the nickel source is selected from at least one of nickel sulfate, nickel nitrate, or nickel chloride.

Specifically, the cobalt source is selected from at least one of cobalt sulfate, cobalt nitrate, or cobalt chloride.

Specifically, the M source is selected from at least one of M sulfate, M nitrate, or M chloride.

Further, with reference to FIG. 1, a preparation method of a high-nickel low-cobalt ternary positive electrode material having cobalt gradient provided by an embodiment of the present application is described in detail, including the following steps.

Referring to FIG. 1, FIG. 1 is a schematic diagram of a preparation process flow of a high-nickel low-cobalt ternary positive electrode material having cobalt gradient provided by the present application.
S01. A high-nickel single-crystal ternary positive electrode material having cobalt gradient and a preparation method thereof are provided, including the following steps: providing a nickel source, a cobalt source, an M source, a complexing agent, and a precipitating agent; dissolving the nickel source and the M source in water to prepare a salt solution 1; dissolving the cobalt source in water to prepare a salt solution 2;
S02. under stirring, slowly injecting the salt solution 2 into the salt solution 1, and then injecting the mixed salt solution, the complexing agent, and the precipitating agent into a reaction kettle to prepare a precursor of high-nickel ternary material having cobalt gradient through co-precipitation reaction. The addition rate of the salt solution 2 is greater than the addition rate of the mixed salt solution to ensure that cobalt source participates more and more in the reaction;
S03. mixing the lithium source with the precursor of high-nickel low-cobalt ternary material, adding the doping agent, and performing sintering treatment with programmed heating under oxygen flow condition in a heating device, and cooling, so as to obtain a high-nickel low-cobalt ternary positive electrode material having cobalt gradient.

In an embodiment of the present application, one part of the nickel source and the manganese source is dissolved in water to prepare the salt solution 1; another part of the cobalt source is dissolved in the water to prepare the salt solution 2. Specifically, the configuration of the salt solution 1 and the salt solution 2 may be achieved by dispersing various metal salts in water, for example the dissolution of the salt solutions is promoted through stirring, etc.

Commonly used precipitating agents and complexing agents in the art can be used as the precipitating agent and the complexing agent in embodiments of the present application. For example, sodium hydroxide solution is selected as the precipitating agent, and an ammonia solution is selected as the complexing agent.

In the above step S02, the embodiment of the present application adopts a wet chemical method that is simple to operate and easy to control for controlling cobalt to participate in the reaction. Individual elements may be mixed evenly at the atomic level, avoiding phase segregation and facilitating industrial production. Specifically, the salt solution 2 is continuously and slowly injected into the salt solution 1 to achieve the gradual addition of the cobalt source, and along with the increase of the amount of the salt solution 2 added, the cobalt content in the obtained mixed salt solution also increases accordingly. At the same time, the complexing agent and the precipitating agent are added to the obtained mixed salt solution for co-precipitation reaction to prepare a precursor of high-nickel ternary material having cobalt gradient.

In the preparation method of the high-nickel ternary positive electrode material having cobalt gradient provided by the embodiments of the present application, the salt solution 2 is continuously and slowly injected into the salt solution 1, and at the same time, the obtained salt solution, the complexing agent and the precipitating agent are subjected to co-precipitation reaction, and the doping agent is added. As the reaction proceeds, the ingredients of the salt solution 1 in the mixed salt solution gradually decrease, while the ingredients of the salt solution 2 gradually increase. That is, the concentration of cobalt in the mixed salt solution gradiently increases over time, achieving the gradient compounding of the cobalt source, effectively controlling the morphology and quality of the precursor and ensuring the performance of the finished product.

Specifically, during the cobalt gradient co-precipitation reaction, in the early stage of the reaction, the concentration of the cobalt solution is at a relatively low level; in the middle and late stages of the reaction, particles of the precursor are mainly in the stage of growing up, and an increase in the concentration of the cobalt salt has little effect on this stage. Therefore, during the preparation process of the high-nickel ternary positive electrode material, the cobalt source is gradiently doped and thus a precursor having high nickel, low cobalt, and cobalt gradient distribution may be prepared, which is beneficial to improving the capacity and other performance of the final product.

In the present application, the distribution of Co element in the particle size of the high-nickel ternary material should satisfy the following characteristics:
\textcircled{1} cobalt element exhibits gradient distribution in the material;
\textcircled{2} the concentration of cobalt element in the surface region and near-surface region of the material is higher than the concentration of cobalt element in the interior;
\textcircled{3} the crystal nucleus may has no cobalt, and the reaction goes on for a period of time for growing, and then the cobalt source is added;
\textcircled{4} as the reaction proceeds, the addition amount of the cobalt source gradually increases.

In order to promote efficient mixing of the two and prevent the concentration of cobalt in local regions from being too high, the embodiment of the present application achieves uniform dispersion of the salt solution 2 in the salt solution 1 through stirring, and the faster the stirring speed, the better. For example, uniform dispersion of the salt solution 2 in the salt solution 1 may be completed within 5 seconds. Moreover, the cobalt source may be added according to the degree of reaction to prepare crystal grains with no cobalt in the nucleus and cobalt distributed in the near-surface region.

During the co-precipitation reaction, both temperature and pH will affect the morphology of particles of the precursor. Only when the temperature and pH are kept within a reasonable range, the metal salts can be orderly precipitated to obtain a precursor with qualified morphology, and thus the processing performance and electrical performance of the final product can be guaranteed.

Specifically, the conditions for preparing the precursor of the gradient-doped high-nickel ternary positive electrode material through co-precipitation reaction are: a temperature of 60° C.±5° C., a pH of the solution system of 10-12, and a reaction time of 18-36 h.

In an embodiment of the present application, feed rates of the salt solution and the complexing agent are kept constant, and the feed rate of the alkaline precipitating agent is dynamically fine-tuned to control the pH of the reaction system to remain constant.

In an embodiment, the molar ratio of the lithium source to the precursor of the high-nickel ternary positive electrode material is (1-1.04):1. The method of mixing the lithium source and the precursor of high-nickel ternary material is not strictly limited, and conventional mixing methods may be used in the embodiments of the present application.

The obtained mixed material is placed in a heating device, which includes but not limited to a sintering furnace. The sintering treatment is carried out with programmed heating under oxygen flow condition. In an embodiment, the temperature is raised to 400-500° C. at a heating rate of 1-3° C./min, and the temperature is held for 5-8 h, then the temperature is raised to 700-900° C. at a heating rate of 1-10° C./min, and the temperature is held for 12-24 h. The programmed heating method is conducive to maintaining the integrity of the high-nickel ternary material particles, preventing the particles from cracking or breaking, and ensuring the electrochemical performance and other performance of the material.

The doping-modified ternary positive electrode material provided by the embodiments of the present application is prepared by the above-mentioned method of the present application, having the advantages of cobalt gradient distribution, regular morphology, and uniform size.

The present application further provides a lithium-ion battery, the positive electrode material thereof includes the high-nickel ternary positive electrode material described in any one of the above technical solutions or the high-nickel ternary positive electrode material prepared by the preparation method described in any one of the above technical solutions.

In the present application, the lithium-ion battery includes a lithium-ion power battery.

In the present application, the high-nickel ternary positive electrode material includes a high-nickel low-cobalt positive electrode material.

The above content of the present application provides a high-nickel ternary positive electrode material having cobalt gradient and a preparation method thereof, and a lithium-ion battery. A high-nickel ternary positive electrode material is specially designed, which has a specific structure with cobalt element distributed gradiently from inside to outside, and a high-nickel low-cobalt positive electrode material products having good stability can be directly obtained. Doping elements in the present application occupy the positions of Ni²⁺and Co³⁺in the positive electrode material, reducing the cation disorder in the lithium layer. On the other hand, the ion radius of the doping elements is larger than that of Mn²⁺, thus the unit cell may be broadened to provide a larger space for the deinsertion and insertion of Li⁺, which is conducive to the deinsertion and insertion of Li⁺, thereby improving the rate performance of the positive electrode material. However, since Li⁺will react with H₂O and CO₂ to generate residual alkali in the near-surface region and the surface region of the material, there is a risk of material cracking and failure after multiple cycles. A positive electrode material having higher cobalt content in the near-surface region and surface region is specially designed in the present application. High-content cobalt may react with Li⁺that cannot be re-inserted to generate lithium cobaltate, this stabilizes the layered structure and suppresses cation disorder, and increases part of the capacity and avoids the generation of residual alkali, thereby improving the capacity and cycle performance of the high-nickel ternary positive electrode material and reducing problems such as residual alkali and gas generation. Furthermore, in the present application, the material having cobalt gradient is designed starting from the precursor, ensuring good electrical performance, cycle stability and low residual alkali of the high-nickel low-cobalt material. There is no artificially designed coating layer, and the complexity of the subsequent process is reduced, and the present application has the characteristics of simple process, low cost and being suitable for large-scale industrialization.

The present application further provides a preparation method for a high-nickel low-cobalt ternary positive electrode material having cobalt gradient. The cobalt source is gradiently added over time during the preparation process to directly obtain a high-nickel low-cobalt precursor of the high-nickel ternary material. The cobalt element is distributed gradiently from inside to outside. Compared with conventional high-nickel low-cobalt ternary positive electrode materials, the high-nickel ternary positive electrode material prepared using the precursor ensures high capacity, and at the same time, the artificially designed coating layer is replaced with the near-surface region having higher cobalt content, thus there is no risk of failure caused by the detaching or cracking of the coating layer, therefore, the high-nickel ternary positive electrode material has more excellent stability. A high-nickel low-cobalt precursor of high-nickel ternary material is directly obtained in the present application, and the provided preparation method of the ternary positive electrode material having cobalt gradient is simple and easy to implement with mild and controllable conditions, and is more suitable for large-scale industrial production, and the morphology and quality of the precursor are effectively controlled to ensure the performance of the finished positive electrode material.

The experimental results show that there was little difference in the capacity, residual alkali, and gas generation rate of the batteries in Comparative Examples 1 and 2, however the capacity, cycle, residual alkali, and gas generation rate of the positive electrode materials and batteries obtained in Examples 1, 2 and 3 were all significantly improved, indicating that the performance of the positive electrode material is significantly improved in a situation that the content of cobalt in the outer surface region of the low-cobalt high-nickel material is high, and the higher the cobalt content, the better the performance of the material.

Comparative Examples 3, 4, 5, 6, 7, 8 all had the above-mentioned similar effects after the proportion of raw materials were changed and comparison with the corresponding examples was conducted.

In order to further illustrate the present application, a high-nickel ternary positive electrode material, a preparation method thereof, and a lithium-ion battery provided by the present application are described in detail below in conjunction with the examples. However, it should be understood that these examples are implemented under the premise of the technical solutions of the present application. The detailed implementations and specific operational processes are given only to further illustrate the features and advantages of the present application, and are not intended to limit the claims of the present application, and the protection scope of the present application is not limited to the following examples.

### Example 1

A high-nickel ternary positive electrode material having cobalt gradient and a preparation method thereof were provided, including the following steps.
(1) Nickel sulfate and manganese sulfate were prepared into a salt solution 1 with a molar ratio of Ni:Mn=83:12, and the total concentration of the salt solution 1 was 2.2 mol/L; cobalt sulfate was prepared into a salt solution 2 with a concentration of 2.2 mol/L, and the molar ratio for the salt solution 2 and the salt solution 1 is Ni:Mn:Co=83:12:5; a sodium hydroxide solution with a concentration of 4.4 mol/L and an ammonia solution with a concentration of 2.2 mol/L were prepared.
(2) The salt solution 2 was continuously and slowly added to the salt solution 1 for rapid stirring, at the same time, the obtained mixed salt solution, the ammonia solution and the sodium hydroxide solution were added slowly into a reaction kettle at a certain speed. Under the conditions satisfying the above equation, which the reaction conditions were: a temperature of 60-63° C., a pH of the solution system of 10-11, and a reaction time of 15-20 h, the precipitate is subjected to suction filtration, washing, and drying to obtain a high-nickel ternary material precursor.
(3) The above-mentioned ternary material precursor and lithium hydroxide were mixed evenly at a ratio of 1:(1-1.04), and a doping agent TiO was added. The mixture was sintered with oxygen in an atmosphere furnace at 700-900° C. for 12-24 h, cooled, and sieved to obtain the ternary positive electrode material having cobalt gradient distribution.

The ternary positive electrode material having cobalt gradient distribution prepared by Example 1 of the present application was characterized.

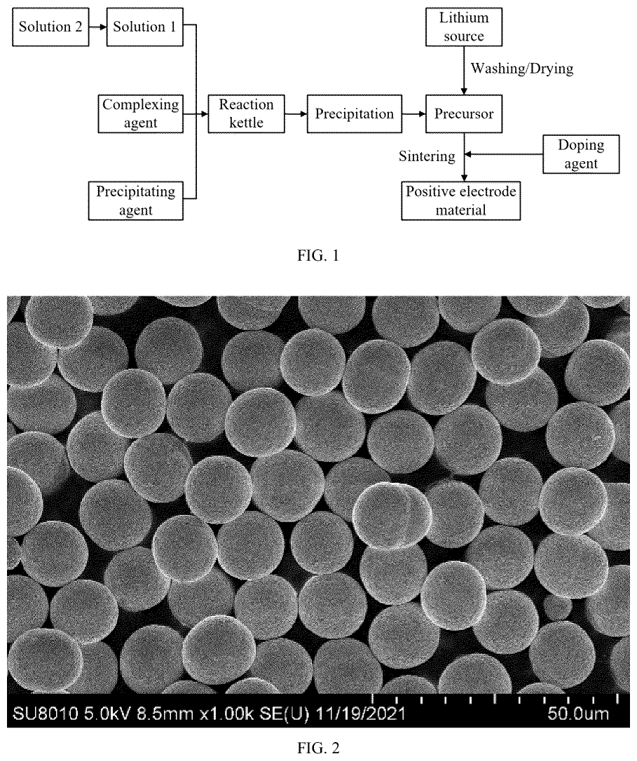

Referring to FIG. 2, FIG. 2 is a high-magnification scanning electron microscope image of the precursor of the high-nickel ternary positive electrode material having cobalt gradient prepared by Example 1 of the present application.

### Comparative Example 1

A high-nickel ternary positive electrode material having cobalt gradient and a preparation method thereof were provided, including the following steps.
(1) Nickel sulfate, manganese sulfate, and cobalt sulfate were prepared into a metal salt solution with a molar ratio of Ni:Mn:Co=83:12:5, and a total concentration of the solution of 2.2 mol/L; a sodium hydroxide solution with a concentration of 4.4 mol/L was prepared, and an ammonia solution with a concentration of 2.2 mol/L was prepared.
(2) The metal salt solution, ammonia solution and sodium hydroxide solution were continuously and slowly added into a reaction kettle at a certain speed. The reaction conditions were: a temperature of 60-63° C., a pH of the solution system of 10-11, and a reaction time of 15-20 h. The precipitate is subjected to suction filtration, washing, and drying to obtain a precursor.
(3) The above-mentioned precursor and lithium hydroxide were mixed evenly at a ratio of 1:1 to 1:1.04, and a doping agent ZrO was added. The mixture was sintered with oxygen in an atmosphere furnace at 700-900° C. for 12-24 h, cooled, and sieved to obtain the ternary positive electrode material having cobalt gradient distribution.

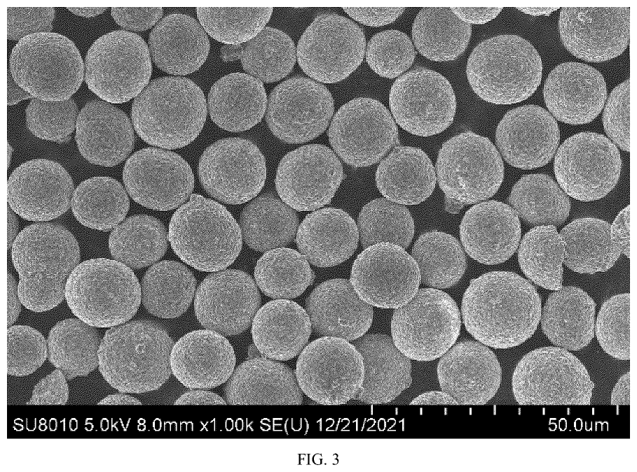

In the process of preparing uniformly doped lithium nickel cobalt manganate positive electrode material in Comparative Example 1, the SEM of the high-nickel ternary material precursor obtained is shown in FIG. 3.

Referring to FIG. 3, FIG. 3 is a high-magnification scanning electron microscope image of the precursor of the high-nickel ternary positive electrode material having cobalt gradient prepared by Comparative Example 1 of the present application.

It can be seen from the comparison of FIG. 2 and FIG. 3, the morphology of the high-nickel ternary material precursor prepared by the Comparative Example, is obviously inferior to the high-nickel ternary material precursor provided by Example 1 of the present application, and the size uniformity is poor, and cobalt element is uniformly distributed.

### Examples 2 to 12, Comparative examples 2 to 8

Based on Example 1, the element ratios or process parameters were adjusted to obtain Examples 2 to 12.

Based on Comparative Example 1, the element ratios or process parameters were adjusted to obtain Comparative Examples 2 to 8.

Referring to Table 1, Table 1 shows statistics of the proportions and process in the Examples and Comparative Examples of the present application.

TABLE 1

| | | | | | | Co addition in |
|---|---|---|---|---|---|---|
| | | | | | | the 0-1.5 μm |
| | | | Molar ratio | | | surface region |
| | | | of doping | | | based on total |
| | | | agent/metal | D50 | Distribution | Co addition |
| Item | Solution 1 | Solution 2 | (mol %) | (μm) | of Co | (%) |
| Comparative | Ni:Mn = | Co = 10% | ZrO/0.28 | 10.3 | Uniform | 34 (low |
| Example 1 | 70%:20% | | | | | concentration) |
| Comparative | Ni:Mn = | Co = 10% | ZrO/0.28 | 10.3 | Gradient | 34 (low |
| Example 2 | 70%:20% | | | | | concentration) |
| Example 1 | Ni:Mn = | Co = 10% | ZrO/0.28 | 10.3 | Gradient | 56 (high |
| | 70%:20% | | | | | concentration) |
| Example 2 | Ni:Mn = | Co = 10% | ZrO/0.28 | 10.3 | Gradient | 65 (high |
| | 70%:20% | | | | | concentration) |
| Example 3 | Ni:Mn = | Co = 10% | ZrO/0.28 | 10.3 | Gradient | 74 (high |
| | 70%:20% | | | | | concentration) |
| Comparative | Ni:Mn = | Co = 5% | TiO/0.34 | 9.5 | Uniform | 31 (low |
| Example 3 | 83%:12% | | | | | concentration) |
| Comparative | Ni:Mn = | Co = 5% | TiO/0.34 | 9.5 | Gradient | 22 (low |
| Example 4 | 83%:12% | | | | | concentration) |
| Example 4 | Ni:Mn = | Co = 5% | TiO/0.34 | 9.5 | Gradient | 59 (high |
| | 83%:12% | | | | | concentration) |
| Example 5 | Ni:Mn = | Co = 5% | TiO/0.34 | 9.5 | Gradient | 67 (high |
| | 83%:12% | | | | | concentration) |
| Example 6 | Ni:Mn = | Co = 5% | TiO/0.34 | 9.5 | Gradient | 75 (high |
| | 83%:12% | | | | | concentration) |
| Comparative | Ni:Mn = | Co = 3% | MgO/0.41 | 11.4 | Uniform | 38 (low |
| Example 5 | 92%:5% | | | | | concentration) |
| Comparative | Ni:Mn = | Co = 3% | MgO/0.41 | 11.4 | Gradient | 28 (low |
| Example 6 | 92%:5% | | | | | concentration) |
| Example 7 | Ni:Mn = | Co = 3% | MgO/0.41 | 11.4 | Gradient | 57 (high |
| | 92%:5% | | | | | concentration) |
| Example 8 | Ni:Mn = | Co = 3% | MgO/0.41 | 11.4 | Gradient | 68 (high |
| | 92%:5% | | | | | concentration) |
| Example 9 | Ni:Mn = | Co = 3% | MgO/0.41 | 11.4 | Gradient | 78 (high |
| | 92%:5% | | | | | concentration) |
| Comparative | Ni:Al = | Co = 2% | Nb₂O₅/0.37 | 10.5 | Uniform | 33 (low |
| Example 7 | 96%:2% | | | | | concentration) |
| Comparative | Ni:Al = | Co = 2% | Nb₂O₅/0.37 | 10.5 | Gradient | 37 (low |
| Example 8 | 96%:2% | | | | | concentration) |
| Example 10 | Ni:Al = | Co = 2% | Nb₂O₅/0.37 | 10.5 | Gradient | 60 (high |
| | 96%:2% | | | | | concentration) |
| Example 11 | Ni:Al = | Co = 2% | Nb₂O₅/0.37 | 10.5 | Gradient | 70 (high |
| | 96%:2% | | | | | concentration) |
| Example 12 | Ni:Al = | Co = 2% | Nb₂O₅/0.37 | 10.5 | Gradient | 79 (high |
| | 96%:2% | | | | | concentration) |

The performance of the positive electrode materials prepared in the Examples and Comparative Examples of the present application was tested.

### Electrochemical Performance Testing

Preparation of positive electrode sheet: the prepared ternary positive electrode material, SP (Super P), KS-6, PVDF (Polyvinylidene Fluoride) were dissolved in NMP (N-Methyl-2-pyrrolidone) by magnetic stirring with a mass ratio of 94.5% :2% :1.0% :2.5%, and the mixture is stirred into a paste slurry. The slurry is then coated on a 15 μm thick aluminum foil current collector using a coating machine and rolled into shape, dried in an oven at 125° C., and cut into a positive electrode sheet of required size.

Preparation of negative electrode sheet: graphite, SP, CMC (Carboxymethyl Cellulose) and SBR (Styrene-Butadiene Rubber) were dissolved in deionized water by magnetic stirring with a mass ratio of 95.5% :1% :1.5% :2.0%, and the mixture is stirred into a paste slurry. The slurry is then coated on a 10 μm thick copper foil current collector using a coating machine and rolled into shape, dried in the oven at 115° C., and cut into a negative electrode sheet of required size.

Battery assembly: the positive electrode sheet, a separator PP, and the negative electrode sheet were rolled into a required battery core, which was baked in the oven at 85° C. for 10 h, and then packaged with an aluminum plastic film and welded with the tabs, and after the short circuit test, it was continuously baked for 20 h to test the moisture content. After the moisture content is qualified, processes such as liquid injection, exhaust, sealing, pre-charging, formation, and aging were performed to obtain the required battery.

See Table 2, Table 2 shows the statistics of performance of the batteries prepared using the positive electrode materials prepared by the Examples and Comparative Examples of the present application.

TABLE 2

| | | Cycle/number | | | | |
|---|---|---|---|---|---|---|
| | Capacity | of times | Li₂CO₃ | LiOH | Free Li⁺ | Gas generation |
| Item | (mAh/g) | (95% SOC) | (ppm) | (ppm) | (ppm) | rate (%) |
| Comparative | 184 | 366 | 3591 | 4526 | 2189 | 36.9 |
| Example 1 | | | | | | |
| Comparative | 184 | 336 | 3891 | 4226 | 2066 | 40.9 |
| Example 2 | | | | | | |
| Example 1 | 187 | 482 | 643 | 1721 | 1157 | 13.5 |
| Example 2 | 188 | 576 | 610 | 1635 | 1048 | 11.8 |
| Example 3 | 188 | 609 | 597 | 1612 | 987 | 10.6 |
| Comparative | 189 | 315 | 3705 | 4230 | 1078 | 36.4 |
| Example 3 | | | | | | |
| Comparative | 189 | 369 | 3619 | 4458 | 1178 | 33.1 |
| Example 4 | | | | | | |
| Example 4 | 193 | 463 | 809 | 1321 | 521 | 12.7 |
| Example 5 | 194 | 530 | 768 | 1298 | 510 | 11.9 |
| Example 6 | 195 | 597 | 745 | 1172 | 498 | 10.6 |
| Comparative | 214 | 273 | 5349 | 6372 | 1295 | 37.6 |
| Example 5 | | | | | | |
| Comparative | 214 | 254 | 5037 | 6041 | 1179 | 34.6 |
| Example 6 | | | | | | |
| Example 7 | 216 | 480 | 928 | 1292 | 617 | 16.8 |
| Example 8 | 216 | 519 | 901 | 1108 | 602 | 15.3 |
| Example 9 | 217 | 544 | 868 | 1085 | 579 | 13.1 |
| Comparative | 216 | 219 | 6276 | 8089 | 1499 | 46.6 |
| Example 7 | | | | | | |
| Comparative | 216 | 232 | 5957 | 8836 | 1702 | 49.8 |
| Example 8 | | | | | | |
| Example 10 | 223 | 439 | 1822 | 1786 | 1081 | 19.2 |
| Example 11 | 223 | 459 | 1573 | 1600 | 923 | 17.7 |
| Example 12 | 224 | 484 | 1306 | 1453 | 809 | 16.2 |

Note:
95% SOC refers to when the battery capacity retention rate is 95% of the initial capacity.

The above is a detailed description of a high-nickel ternary positive electrode material having cobalt gradient, a preparation method thereof and a lithium-ion battery provided by the present application. Specific examples are used herein to illustrate the principles and embodiments of the present application. The above description of examples is only used to aid in the understanding of the method of the present application and its main ideas, including the best embodiments, and also to enable any person skilled in the art to practice the present application, including making and using any device or system, and implementing any combined method. It should be noted that for the person skilled in the art, several improvements and modifications may also be made to the present application without departing from the principles of the present application, and these improvements and modifications also fall within the protection scope of the claims of the present application. The patent protection scope of the present application is defined by the claims, and may include other embodiments that may be conceived by the person skilled in the art. These other embodiments shall also be included within the scope of the claims if they have structural elements that do not differ from the literal expressions of the claims, or if they include equivalent structural elements having no substantial differences from the literal expressions of the claims.

What is claimed is:

1. A high-nickel ternary positive electrode material, having a structural formula of LiₓNiₐM_{b}Co_{c}N_{z}O₂;
wherein 1≤x≤1.04, 0.70≤a≤0.96, 0.02≤b≤0.28, 0.001≤z≤0.015, c=1−a−b, c>0;
M comprises one or more of Mn, Al, Mg, and Fe;
N comprises one or more of Ti, Ta, B, Sc, Sn, Y, Zr, Mg, Cr, Nb, W, and Mo; and
a content of a cobalt element within a range of 1.5 μm from a surface of the positive electrode material accounts for 48%-85% of a content of the cobalt element in the positive electrode material.

2. The high-nickel ternary positive electrode material according to claim 1, wherein the positive electrode material has a uniform spherical particle morphology; and
a particle size of the positive electrode material is 3.2-20 μm.

3. The high-nickel ternary positive electrode material according to claim 1, wherein the cobalt element is distributed in a decreasing gradient from the surface to a center of the positive electrode material;
in the positive electrode material, a concentration of the cobalt element in a surface region and a near-surface region is higher than that in an interior.

4. The high-nickel ternary positive electrode material according to claim 1, wherein a center of the positive electrode material does not contain the cobalt element;
the positive electrode material does not have a coating structure or a composite structure;
the ternary positive electrode material comprises a single-crystal ternary positive electrode material or a poly-crystal ternary positive electrode material.

5. A preparation method for a high-nickel ternary positive electrode material, comprising the following steps:
1) mixing a nickel source, an M source and water to obtain a salt solution;
2) injecting a cobalt source solution into the salt solution at first, and at the beginning of obtaining a mixed salt solution, injecting the mixed salt solution, a complexing agent and a precipitating agent into a reaction device for a co-precipitation reaction, and after a period of solution, and continuously injecting the mixed salt solution, the complexing agent and the precipitating agent into the reaction device for the co-precipitation reaction, to finally obtain a ternary material precursor;
3) continuously mixing the ternary material precursor obtained in the above steps, a lithium source and a doping agent, and then sintering in an oxygen-containing atmosphere, to obtain the high-nickel ternary positive electrode material.

6. The preparation method according to claim 5, wherein a total concentration of the nickel source and the M source in the salt solution is the same as a concentration of the cobalt source solution; and
a ratio of a volume of the cobalt source solution to a total volume of the salt solution is (0.45-1):1.

7. The preparation method according to claim 5, wherein a duration of the period of time is 10-24 h; and
an injection rate of the cobalt source solution is greater than that of the mixed salt solution.

8. The preparation method according to claim 5, wherein the lithium source comprises one or more of lithium carbonate, lithium nitrate, lithium acetate, and lithium hydroxide;
the nickel source comprises one or more of nickel sulfate, nickel nitrate, and nickel chloride; and
the cobalt source comprises one or more of cobalt sulfate, cobalt nitrate, and cobalt chloride.

9. The preparation method according to claim 5, wherein the M source comprises one or more of M sulfate, M nitrate, and M chloride;
the complexing agent comprises one or more of aqueous ammonia solution, ammonium sulfate, EDTA, oxalic acid, sodium carbonate, and sodium bicarbonate; and
the precipitating agent comprises one or more of NaOH, Na₂CO₃, H₂C₂O₄, (NH₄)₂C₂O₄, and (NH₄)₂CO₃.

10. The preparation method according to claim 5, wherein a temperature of the co-precipitation reaction is 55-65° C.;
a pH value of a solution system of the co-precipitation reaction is 10-12; and
a time of the co-precipitation reaction is 18-36 h.

11. The preparation method according to claim 5, wherein a volume concentration of oxygen in the oxygen-containing atmosphere is greater than or equal to 90%; and
a molar ratio of the ternary material precursor to the lithium source is 1:(1-1.04).

12. The preparation method according to claim 5, wherein the sintering comprises two-stage of sintering;
a heating rate of a first stage of sintering is 1-3° C./min;
a temperature of the first stage of sintering is 400-500° C.; and
a holding time of the first stage of sintering is 5-8 h.

13. The preparation method according to claim 12, wherein a heating rate of a second stage of sintering is 1-10° C./min;
a temperature of the second stage of sintering is 700-900° C.; and
a holding time of the second stage of sintering is 12-24 h.

14. The preparation method according to claim 5, wherein an addition amount of the doping agent is 0.0002-0.035.

15. A lithium-ion battery, wherein a positive electrode material thereof comprises the high-nickel ternary positive electrode material according to claim 1.

16. A lithium-ion battery, wherein a positive electrode material thereof comprises the high-nickel ternary positive electrode material prepared by the preparation method according to claim 5.

17. The lithium-ion battery according to claim 15, wherein the lithium-ion battery comprises a lithium-ion power battery; and
the high-nickel ternary positive electrode material comprises a high-nickel low-cobalt positive electrode material.

18. The lithium-ion battery according to claim 16, wherein the lithium-ion battery comprises a lithium-ion power battery; and
the high-nickel ternary positive electrode material comprises a high-nickel low-cobalt positive electrode material.
